(19) United States
(12) Patent Application Publication
(10) Pub. No.: US 2003/0012518 A1
(43) Pub. Date: Jan. 16, 2003

(54) Optical fiber coupler receptacle member

(75) Inventors: Satoru Tomaru, Tokyo (JP); Takashi Uetake, Tokyo (JP); Osamu Kobayashi, Tokyo (JP); Hiroaki Akita, Tokyo (JP); Saburo Imamura, Tokyo (JP)

Correspondence Address: CASELLA & HESPOS, 274 MADISON AVENUE, NEW YORK, NY, 10016

(73) Assignee: NTT ADVANCED TECHNOLOGY CORPORATION, Tokyo (JP)

(21) Appl. No.: 10/195,806

(22) Filed: Jul. 12, 2002

(30) Foreign Application Priority Data
Jul. 13, 2001 (JP) 2001-214016

(51) Int. Cl. G02B 6/36; G02B 6/38; G02B 6/26

(52) U.S. Cl. 385/76; 385/55; 385/39

(57) ABSTRACT

An optical fiber coupler receptacle member having simple construction with superior molding ability and can easily perform fixing and coupling operation. The optical fiber coupler receptacle member has a base body formed with a receptacle groove adapting to a shape of an optical fiber coupler having coated fiber portions, bear fiber portions and a molten and elongated portion, and a cover engaged with and covering the base body in order to protect the optical fiber coupler fixed to the base body.

This application is based on Patent Application No. 2001-214016 filed Jul. 13, 2001 in Japan, the content of which is incorporated hereinto by reference.

### BACKGROUND OF THE INVENTION

1. Field of the Invention

The present invention relates to an optical fiber coupler receptacle member for receiving an optical fiber coupler.

2. Description of the Related Art

An optical fiber coupler is typically prepared by heating, melting and elongating two parallel bear fibers tightly fitted with each other. In the portion thinned by elongation, cores of two optical fibers are placed in close proximity with each other. Then, when a light passes through one optical fiber, light leaks to the other optical fiber. Utilizing this, by varying elongation length of molten and elongated portion, directional couplers of various wavelength can be realized. On the other hand, in order to avoid variation of optical fiber coupler characteristics due to influence of distortion by external force and other causes, it becomes necessary to prevent the molten and elongated portion from causing deformation.

There is shown one example of the conventional method for fixing the optical fiber coupler in FIG. 1. In the shown example, a bear fiber portion 1 is fixed to a substrate 6 using an adhesive 7. The substrate is received within a housing 8. Then, the substrate 6 and coated fiber portions 5A and 5B of the optical fiber coupler are bonded and secured to the housing by adhesives 7A, 7B and 7C. By fixing the substrate 6 to the housing 8 at one point, transmission of deformation of the housing 8 due to external force to the molten and elongated portion is avoided. Further, by fixing the bear fibers 1 at coating removed ends 5C and 5D of the optical fiber coupler with adhesives 7D and 7E, mutual slip between the bear fiber 1 and the coating is prevented. Thus, even when external force is applied to the coated fiber portion located outside of the housing 8, the force may not be transmitted to the molten and elongated portion.

Furthermore, in viewpoint of lowering of price of the optical fiber coupler, lowering of production cost of the substrate and housing and simplification of production process of the optical fiber coupler are required. In order to achieve these objects, there has been proposed an optical fiber coupler receptacle member, in which the substrate for fixing the optical fiber coupler and a part of casing for receiving the substrate are formed by integral molding of plastic (see Japanese Patent Application Laid-Open No. 1-182810 (1989)).

This prior art is illustrated in FIGS. 2A and 2B. FIG. 2A is a front elevation and FIG. 2B is a side view. In the shown construction, a substrate 10 and a housing base body 9 are connected at a shown connecting portion 11. As a material, a liquid crystal polymer having smaller linear expansion coefficient is used. In the substrate portion, continuous glass fibers are filled in parallel to longitudinal direction of the optical fiber coupler. The optical fiber coupler is fixed to the substrate by an ultraviolet curing adhesive. A housing cover 12 is fitted over the substrate and fixed by an ultrasonic bonding. As a result, the linear expansion coefficient of the optical fiber coupler becomes substantially equal to materials of the substrate and the housing. Furthermore, by using special plastic which is easy to mold complicate shape, the optical fiber coupler receptacle member, in which the substrate and housing are separately formed conventionally, are molded integrally at low cost.

However, in the conventionally proposed optical fiber coupler receptacle member formed of plastic material, the substrate and the housing are connected at one point to achieve satisfactory performance. However, because of the structure where the substrate and the housing are connected at one point, a mold structure for plastic molding becomes complicate to lower productivity and yield to result in high price of individual molded product. On the other hand, while it has been proposed to use adhesive bonding or ultrasonic bonding for fixing the substrate and housing, since the liquid crystal polymer is non-adhesive molding material, sufficient bonding strength cannot be obtained by the adhesive bonding, and since connected portion becomes thin in optical fiber coupler in the case of ultrasonic bonding, breakage of the coupler may be caused when the ultrasonic wave is too strong, and insufficient bonding may be made when the ultrasonic wave is too weak, resulting in difficulty in production control.

### SUMMARY OF THE INVENTION

The present invention has been worked out in view of the drawbacks set forth above. Therefore, it is an object of the present invention to provide an optical fiber coupler receptacle member which is superior in molding ability with simple structure and fixing and bonding operation can be done easily.

According to an aspect of the present invention, there is provided an optical fiber coupler receptacle member comprising:

a base body formed with a receptacle groove adapting to a shape of an optical fiber coupler having coated fiber portions, bear fiber portions and a molten and elongated portion; and

a cover engaged with and covering the base body so as to protect the optical fiber coupler fixed to the base body.

Here, the receptacle groove may be formed, at opposite end portions thereof, with a width equal to a width of the coated fiber portions of the optical fiber coupler and a depth corresponding to a half of a diameter of the coated fiber portions, and grooves having a width equal to a width of the coated fiber portions of the optical fiber coupler and a depth corresponding to a half of a diameter of the coated fiber portions are formed in the cover at positions corresponding to a position of the receptacle groove.

Alternatively, the receptacle groove may be formed, at opposite end portions thereof, with a width equal to a width of the coated fiber portions of the optical fiber coupler and a depth corresponding to a diameter of the coated fiber portions, and grooves having a width equal to a width of the coated fiber portions of the optical fiber coupler and a depth corresponding to a diameter of the coated fiber portions are formed in the cover at positions corresponding to a position of the receptacle groove.

Here, it is preferred that the receptacle groove is formed such that a bottom of a portion receiving the bear fiber portions and the molten and elongated portion is shallower than a bottom of portions receiving the coated fiber portions to an extent corresponding to a thickness of a coating.

Further, it is preferred that in the receptacle groove, adhesive receptacle grooves are provided at positions corresponding to opposite end portions of the molten and elongated portion of the optical fiber coupler for fixing the optical fiber coupler.

Still further, it is preferred that in the base body, first engaging ridge portions projecting from base planes and second engaging ridge portions projecting from the first engaging ridge portions are formed on both sides of the receptacle groove, and in the cover, first and second engaging recessed portions engaging with the first and second engaging ridge portions, respectively, are formed.

Yet further, it is preferred that the base body and the cover are plastic molded products of liquid crystal polymer based composite material.

Finally, it is preferred that the liquid crystal polymer based composite material contains continuous fibers of carbon or glass.

As set forth above, in the present invention, the receptacle groove adapted to the shape of the optical fiber coupler is preliminarily formed on the base body for fixing the optical fiber coupler. In order to prevent the optical fiber coupler from causing deformation due to an external stress and to certainly fixing the optical fiber coupler onto the base body, grooves are formed at opposite ends of the receptacle groove for receiving adhesive for fixing the optical fiber coupler. Therefore, the base member may have simple shape to permit significant reduction of cost for mold and cost for molding process for performing injection molding.

On the other hand, the optical fiber coupler receptacle member according to the present invention is constructed with the base body for fixing the optical fiber coupler and the cover fitted over the base body for protecting the optical fiber coupler, and the base body and the cover are firmly engaged so as not to require adhesive or ultrasonic bonding.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is an illustration showing one example of the conventional fixing method of an optical fiber coupler;

FIGS. 2A and 2B are illustrations showing one example of the conventional fixing method using a plastic molded body, in which FIG. 2A is a front elevation and FIG. 2B is a side view;

FIGS. 3A and 3B are general illustrations of an optical fiber coupler to be received in an optical fiber coupler receptacle member according to the present invention, in which FIG. 3A is a plan view and FIG. 3B is a side view;

FIG. 4 is an exploded perspective view of a base body and a cover forming one embodiment of the optical fiber coupler receptacle member according to the present invention;

FIGS. 5A to 5D are sections showing engaging condition between the base body and the cover in one embodiment of the invention, wherein FIGS. 5A, 5B, 5C and 5D are sections taken along lines VA-VA, VB-VB, VC-VC and VD-VD, respectively, in FIG. 4;

FIGS. 6A to 6D are sections of another embodiment of the present invention at positions corresponding to FIGS. 5A, 5B, 5C and 5D; and

FIG. 7 is a diagram showing a heat cycle test result of the optical fiber coupler packaged with the receptacle member according to the invention.

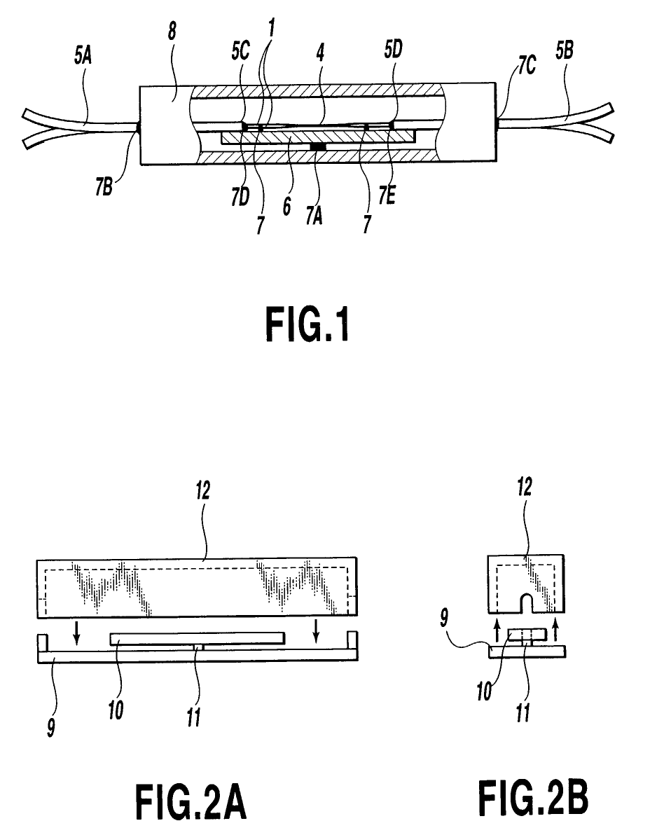

### DETAILED DESCRIPTION OF PREFERRED EMBODIMENTS

Embodiments of the present invention will be described hereinafter with reference to the accompanying drawings.

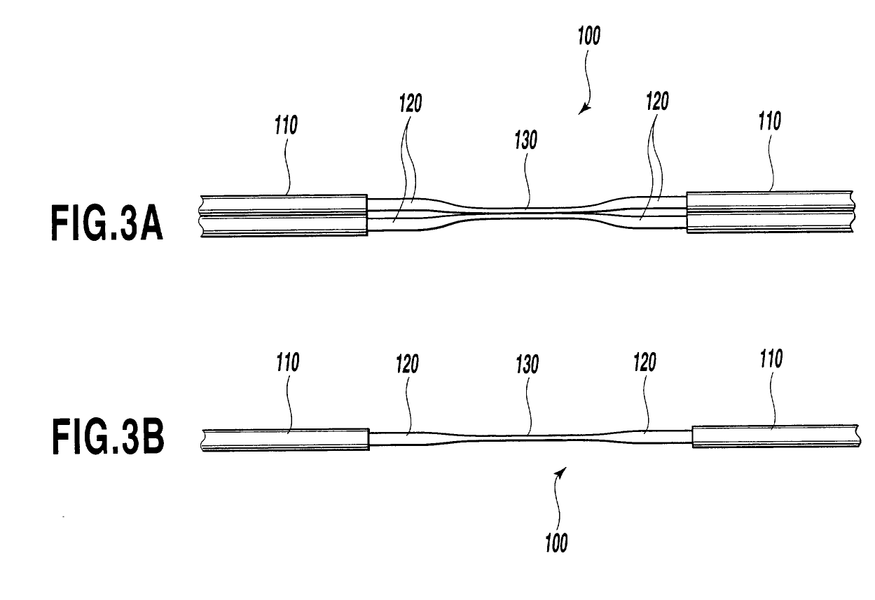

At first, general illustration of an optical fiber coupler 100 to be received in an optical fiber coupler receptacle member according to the present invention is shown in FIGS. 3A and 3B. The optical fiber coupler 100 is generally constructed with coated fiber portions 110, bear fiber portions 120 and a molten and elongated portion 130. In the shown embodiment, the optical fiber coupler is produced by processing an optical fiber having coated fiber portion 110 having 250 μm of external diameter of coating. Coating removal length, namely a length of the bear fiber portions 120 and the molten and elongated portion 130 is 40 mm. It should be noted that there is exemplified the case where an external diameter of the bear fiber portion 120 removed the coating is 125 μm.

In a production process of the optical fiber coupler 100, preheating is initially performed in order to remove strain of the fiber by a ceramic micro-heater. Thereafter, the optical fibers are fuse bonded and then subject to a precise elongation process. In each heating process, a processing temperature is monitored by an infrared temperature detector. In order to produce an optical fiber coupler having a predetermined optical output, optical output is checked by an optical output judgment device for terminating elongation at a timing where a condition is satisfied. At this time, the length of the coating removed portion is 40 mm.

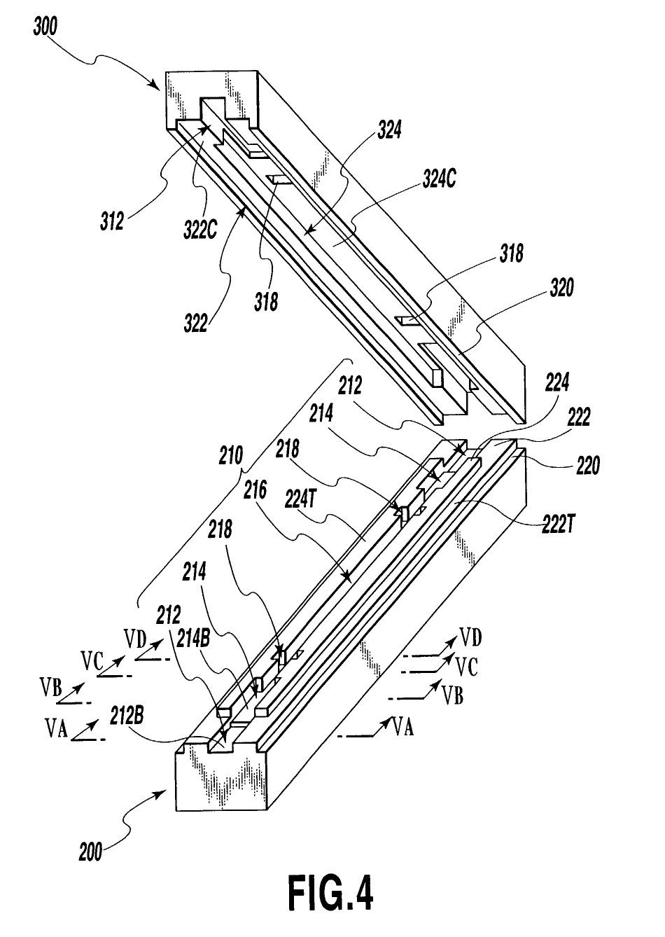

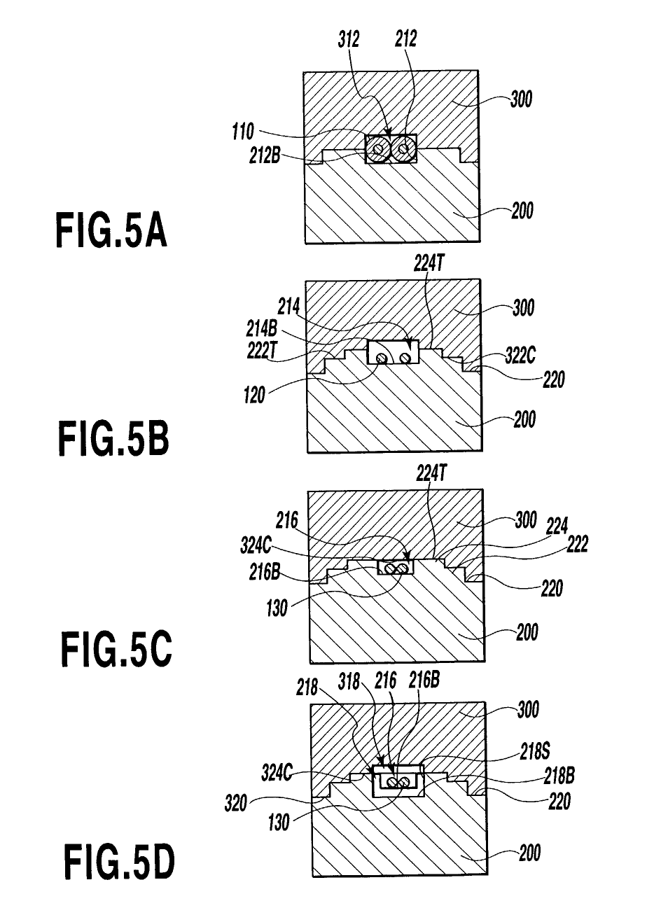

FIG. 4 is an exploded perspective view showing a base body 200 and a cover 300 forming one embodiment of the optical fiber coupler receptacle member according to the present invention. FIGS. 5A, 5B, 5C and 5D are sections at various positions taken along lines VA-VA, VB-VB, VC-VC and VD-VD of FIG. 4, in the condition where the base body 200 and the cover 300 are engaged.

The base body 200 has a predetermined length (e.g. 46 mm) corresponding to the length of the coating removed portion. In the base body 200, in order to fix the optical fiber coupler 100 having the foregoing coated fiber portions 110, the bear fiber portions 120 and the molten and elongated portion 130, a receptacle groove 210 adapting to the shape thereof is formed along a longitudinal direction of the base body 200. Here, the receptacle groove 210 is consisted of coated fiber portion fixing grooves 212 located at opposite ends of the base body 200, having a predetermined width corresponding to a width of two coated fiber portions 110 (e.g. 500 μm) and having a predetermined depth (e.g. 125 μm or 250 μm), bear fiber portion receiving grooves 214 having the same width as the coated fiber portion fixing grooves 212 and having a depth different from that of the former, and a molten and elongated portion receiving groove 216 located at a center portion of the base body 200, having a width narrower than the coated fiber portion fixing grooves 212 and the bear fiber portion receiving grooves 214 and having a depth equal to that of the bear fiber portion receiving grooves 214.

It should be noted that grooves 312 are formed in the cover 300 with a width equal to a sum of widths of the coated fiber portions present in the optical fiber coupler and a predetermined depth, at a position corresponding to the coated fiber portion fixing grooves 212.

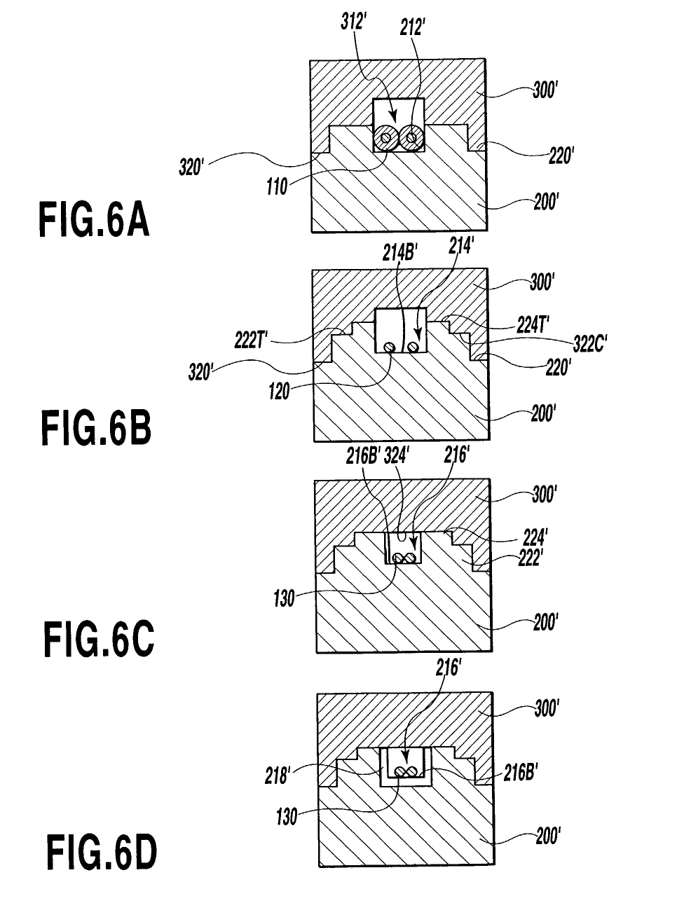

The depth of each coated fiber portion fixing grooves 212 is a depth corresponding to a half of diameter of the coated fiber portion 110 of the optical fiber coupler 100 (e.g. 125 μm, see FIG. 5) in the first aspect, and a depth equal to the diameter of the coated fiber portion 110 (e.g. 250 μm, see FIG. 6) in the second aspect.

Here, in the receptacle groove 210, bottoms 214B of the bear fiber portion receiving grooves 214 receiving the bear fiber portions 120 of the optical fiber coupler 100 and a bottom 216B of the molten and elongated portion receiving groove 216 receiving the molten and elongated portion 130 are shallower than bottoms 212B of the coated fiber portion fixing grooves 212 receiving the coated fiber portions 110 to an extent corresponding to a thickness of the coating (e.g. 62.5 μm).

Furthermore, in the molten and elongated portion receiving groove 216 of the receptacle groove 210, adhesive receptacle grooves 218 to be filled with adhesive for fixing the optical fiber coupler 100, are formed at positions corresponding to opposite ends of the molten and elongated portion 130 of the optical fiber coupler 100. The adhesive receptacle groove 218 is formed with greater width and greater depth in comparison with the molten and elongated portion receiving groove 216 in order to ensure a sufficient amount of adhesive to be filled, and has side walls 218S and a bottom 218B (see FIG. 5D).

In addition, in the base body 200, first engaging ridge portions 222 projecting from a base plane 220 on both sides of the base body 200, are formed on both sides of the receptacle groove 210. Second engaging ridge portions 224 projecting from upper surfaces 222T of the first engaging ridge portions 222 are also formed. It should be noted that the second engaging ridge portion 224 has a dimension in the longitudinal direction corresponding to or equal to the length of the bear fiber portion receiving grooves 214 plus the molten and elongated portion receiving groove 216. In the cover 300, a first engaging recessed portion 322 engaging with the first engaging ridge portions 222 and a second engaging recessed portion 324 engaging with the second engaging ridge portions 224 are formed. Lower surfaces 320 on both sides of the cover 300 mate with the base plane 220 on both sides of the base body 200. Upper surface 322C of the first engaging recessed portion 322 mates with upper surfaces 222T of the first engaging ridge portions 222. The second engaging recessed portion 324 is formed by stepping up from the upper surface 322C of the first engaging recessed portion 322. In the upper surface 324C of the second engaging recessed portion 324, grooves 318 are formed at positions corresponding to the adhesive receptacle grooves 218.

On the other hand, the base body 200 and the cover 300 are plastic molded products of liquid crystal polymer based composite material. It is preferred that the liquid crystal polymer based composite material is prepared by adding continuous fibers of carbon or glass to a liquid crystal polymer matrix.

Fixing of the optical fiber coupler 100 to the base body 200 is performed by applying an adhesive to the coated fiber portion fixing grooves 212 on opposite ends of the base body 200 and filling the adhesive in the adhesive receptacle grooves 218. Subsequently, the optical fiber coupler 100 is set within the receptacle groove 210. At this time, the coated fiber portion 110 of the optical fiber coupler 100 is tightly received within the coated fiber portion fixing grooves 212. The bear fiber portions 120 removed the coating are also mounted on the bottoms 214B of the bear fiber portion receptacle grooves 214 shallower than the bottoms of the coated fiber portion fixing grooves 212, and are held stably. On the other hand, since the adhesive receptacle groove 218 is formed so as to have greater width and greater depth having the side walls 218S and the bottom 218B, the adhesive flows around the molten and elongated portion 130 sufficiently in order to firmly fix the molten and elongated portion 130 to the molten and elongated portion receptacle portion 216. On the other hand, the grooves 318 formed in the cover 300 absorb an extra amount of adhesive in the adhesive receptacle grooves 218. It should be noted that the adhesive is preferably ultraviolet cure adhesive prepared by adding inorganic filler to epoxy type or acryl type adhesive adapting thermal expansion coefficient to quarts glass.

After completing fixing of the optical fiber coupler 100 to the base body 200, the cover 300 is engaged with the base body 200. At this time, the first engaging recessed portion 322 of the cover 300 engages with the first engaging ridge portions 222, and conjunction therewith, the second engaging recess portion 324 engages with the second engaging ridge portions 224 for firmly coupling the base body 200 and the cover 300 by frictional engagement therebetween. Therefore, it does not require any adhesive or ultrasonic bonding for maintaining the cover 300 and the base body 200 in a coupled condition. In the engaged condition of the base body 200 and the cover 300, the optical fiber coupler 100 places the coated fiber portions 110 at the intermediate position between the coated fiber portion fixing groove 212 of the base body 200 and the groove 312 of the cover 300 to make a gap between both grooves and the outer periphery of the coated fiber portion 110 smaller.

Next, the second embodiment of the present invention will be discussed with reference to FIGS. 6A, 6B, 6C and 6D. The second embodiment is primarily differentiated in that while the first embodiment has the coated fiber portion fixing grooves of the base body having a depth corresponding to a half of the diameter of the coated fiber portions 110, the second embodiment has the coated fiber portion fixing grooves having a depth corresponding to the diameter of the coated fiber portions 110. With employing the shown construction, fixing of the optical fiber coupler 100 to the base body can be further assured. Other basic construction is substantially the same as the first embodiment. In the shown second embodiment, like components or like functional portions to those in the first embodiment will be identified by like reference numerals with “'(prime)” for distinction therebetween, in order to avoid redundant discussion and whereby to keep the disclosure simple enough to facilitate clear understanding of the present invention.

In the second embodiment, a depth of grooves 312′of a cover 300′ corresponding to coated fiber portion fixing grooves 212′ of a base body 200′, is set to be the same as that of the coated fiber portion fixing grooves 212′ and equal to the diameter of the coated fiber portions 110 of the optical fiber coupler 100. On the other hand, since the receptacle groove 210′ of the base body 200′ is wholly formed to be deeper, no groove or recess is formed in the cover 300′ at the positions corresponding to the adhesive receptacle grooves 218′ of the base body 200′ as can be clear from FIG. 6D.

While liquid crystal polymer base composite material having small linear expansion coefficient is used as material of the base body and the cover, in the shown embodiment, continuous glass fibers are filled parallel to the longitudinal direction of the optical fiber coupler.

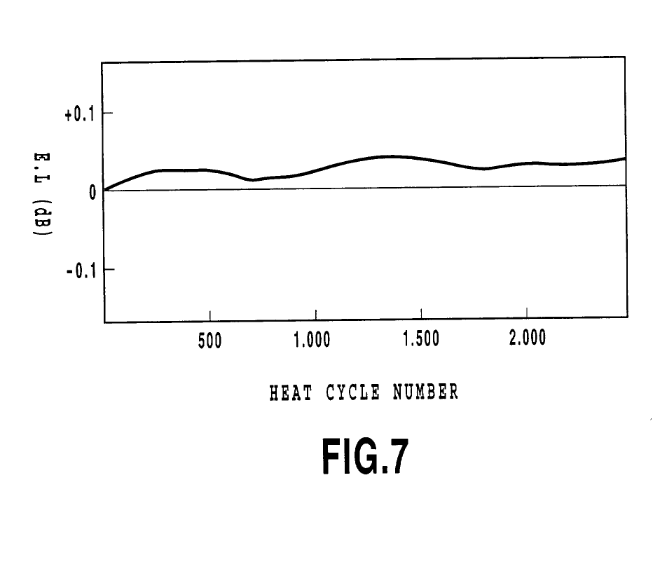

A result of heat cycle test (U.S. Armed Force Standard MIL-STD-8100 Test No. 503.2) for an optical fiber coupler packaged within the receptacle member according to the present invention is shown in FIG. 7. As can be seen from FIG. 7, sufficient practical applicability can be clearly seen.

It should be noted that while description has been given for an example of the receptacle member of the optical fiber coupler having the coating removed portion of 40 mm in length, the dimension and structure of the receptacle member may be adapted for the length and construction of the optical fiber coupler to be received. Also, the receptacle member may have various dimensions in cross-section. Also, in certain case, the present invention may be adapted even for the case where the optical fiber coupler receptacle member is further received in a stainless tube, quartz glass material or the like in order to reinforce the optical fiber coupler receptacle member.

As set forth above, with the present invention, operation for fixing an optical fiber coupler at the same position of the base body can be simplified and necessary operation period can be shortened. Also, since the receptacle member is the plastic molded product, unit price can be lowered and production cost can also be lowered by significantly shortening of process period. Thus, manufacturing cost of the optical fiber coupler can be significantly lowered.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. An optical fiber coupler receptacle member comprising:
a base body formed with a receptacle groove adapting to a shape of an optical fiber coupler having coated fiber portions, bear fiber portions and a molten and elongated portion; and
a cover engaged with and covering said base body so as to protect said optical fiber coupler fixed to said base body.

2. An optical fiber coupler receptacle member as claimed in claim 1, wherein said receptacle groove is formed, at opposite end portions thereof, with a width equal to a width of the coated fiber portions of said optical fiber coupler and a depth corresponding to a half of a diameter of the coated fiber portions, and grooves having a width equal to a width of the coated fiber portions of said optical fiber coupler and a depth corresponding to a half of a diameter of the coated fiber portions are formed in said cover at positions corresponding to a position of said receptacle groove.

3. An optical fiber coupler receptacle member as claimed in claim 1, wherein said receptacle groove is formed, at opposite end portions thereof, with a width equal to a width of the coated fiber portions of said optical fiber coupler and a depth corresponding to a diameter of the coated fiber portions, and grooves having a width equal to a width of the coated fiber portions of said optical fiber coupler and a depth corresponding to a diameter of the coated fiber portions are formed in said cover at positions corresponding to a position of said receptacle groove.

4. An optical fiber coupler receptacle member as claimed in claim 2, wherein said receptacle groove is formed such that a bottom of a portion receiving said bear fiber portions and said molten and elongated portion is shallower than a bottom of portions receiving said coated fiber portions to an extent corresponding to a thickness of a coating.

5. An optical fiber coupler receptacle member as claimed in claim 3, wherein said receptacle groove is formed such that a bottom of a portion receiving said bear fiber portions and said molten and elongated portion is shallower than a bottom of portions receiving said coated fiber portions to an extent corresponding to a thickness of a coating.

6. An optical fiber coupler receptacle member as claimed in claim 4, wherein, in said receptacle groove, adhesive receptacle grooves are provided at positions corresponding to opposite end portions of said molten and elongated portion of said optical fiber coupler for fixing said optical fiber coupler.

7. An optical fiber coupler receptacle member as claimed in claim 5, wherein, in said receptacle groove, adhesive receptacle grooves are provided at positions corresponding to opposite end portions of said molten and elongated portion of said optical fiber coupler for fixing said optical fiber coupler.

8. An optical fiber coupler receptacle member as claimed in claim 1, wherein, in said base body, first engaging ridge portions projecting from base planes and second engaging ridge portions projecting from said first engaging ridge portions are formed on both sides of said receptacle groove, and in said cover, first and second engaging recessed portions engaging with said first and second engaging ridge portions, respectively, are formed.

9. An optical fiber coupler receptacle member as claimed in claim 2, wherein, in said base body, first engaging ridge portions projecting from base planes and second engaging ridge portions projecting from said first engaging ridge portions are formed on both sides of said receptacle groove, and in said cover, first and second engaging recessed portions engaging with said first and second engaging ridge portions, respectively, are formed.

10. An optical fiber coupler receptacle member as claimed in claim 3, wherein, in said base body, first engaging ridge portions projecting from base planes and second engaging ridge portions projecting from said first engaging ridge portions are formed on both sides of said receptacle groove, and in said cover, first and second engaging recessed portions engaging with said first and second engaging ridge portions, respectively, are formed.

11. An optical fiber coupler receptacle member as claimed in claim 8, wherein said base body and said cover are plastic molded products of liquid crystal polymer based composite material.

12. An optical fiber coupler receptacle member as claimed in claim 9, wherein said base body and said cover are plastic molded products of liquid crystal polymer based composite material.

13. An optical fiber coupler receptacle member as claimed in claim 10, wherein said base body and said cover are plastic molded products of liquid crystal polymer based composite material.

14. An optical fiber coupler receptacle member as claimed in claim 11, wherein said liquid crystal polymer based composite material contains continuous fibers of carbon or glass.

15. An optical fiber coupler receptacle member as claimed in claim 12, wherein said liquid crystal polymer based composite material contains continuous fibers of carbon or glass.

16. An optical fiber coupler receptacle member as claimed in claim 13, wherein said liquid crystal polymer based composite material contains continuous fibers of carbon or glass.
